(19) United States
(12) Patent Application Publication
(10) Pub. No.: US 2005/0107997 A1
(43) Pub. Date: May 19, 2005

(54) System and method for resource usage estimation

(76) Inventors: Julian Watts, Thornleigh (AU); James Lownie, Hornsby (AU); Charles Loboz, Hornsby (AU); Jonatan Kelu, Granville (AU)

Correspondence Address: Unisys Corporation, Unisys Way, M/S E8-114, Blue Bell, PA, 19422, US

(21) Appl. No.: 10/507,563

(22) PCT Filed: Mar. 14, 2002
(86) PCT No.: PCT/US02/07590

(51) Int. Cl. G06F 9/44

(52) U.S. Cl. 703/21

(57) ABSTRACT

The present invention provides a method of estimating computing system resource usage by the process of obtaining raw utilisation data from a computing system and applying a mathematical model to the input data, thereby providing an estimate of resource usage for a individual transaction type within the computing environment.

### FIELD OF INVENTION

The present invention relates to a system and method for estimating resource usage for an individual transaction type within a computing environment.

### BACKGROUND OF INVENTION

Resource usage estimation is becoming critical to modern computing systems. The advent of sophisticated multi-tasking and multi-threading operating systems and applications has allowed many transaction types to be executed concurrently on a single computing system.

A computer system will hereinafter be referred to as a transaction processing system for convenience. A transaction processing system may execute many transactions during a normal “day”. In a transaction processing system, transactions may be grouped into subsets termed transaction types. These transaction types refer to functions or procedures carried out by the computer system. For example, there may be a function that calculates the stock level of a particular item, which may be designated by a name such as “stock-level”. In another example, there may be provided a function which generates a new order, and may be designated by a name such as “new-order”. In computer terminology, such transaction types may be generically termed “processes”. That is, a “transaction type” may also be termed a “process”. Transactions belonging to the same type will usually have similar processing profiles. That is, transactions belonging to the same type will usually use a similar proportion of system resources.

Information on usage of computer resources by given transaction type is necessary. It allows a programmer or system administrator to determine the main causes of system resource consumption and thereby attempt to optimise certain transaction types, which results in an improvement in overall efficiency.

However, in contemporary transaction processing systems, the resource usage for transaction types is almost impossible to obtain directly. The central reason for this difficulty is the significant asynchronous nature of system architecture. Many modern transaction processing systems consist of three components of primary interest. These three components are the database, the transaction logic communicating with the database through a database driver, and transaction and session management modules (that is, the application server or the transaction server).

These three components may be mapped in various ways into operating system entities. The database is usually implemented as a set of several processes. The business logic (that is, the database interface) is usually implemented as a series of processes within the transaction and session manager. The transaction and session manager may be implemented as a single multi-threaded process, but multiple process implementations are possible.

Depending on the implementation, it may sometimes be possible to measure processor time used by the business logic part of an individual transaction. Using standard system instrumentation, it is sometimes possible to measure the processor time used by the process executing the business logic, but the structure of the transaction management system may make that impossible.

In principle it is impossible to measure the processor time used by the database to execute given transactions. This is because a database process may be processing several transactions simultaneously and the resource consumption data may be impossible to “untangle” Another factor which makes direct measurement difficult is the relatively fast processing time of modern computing systems. With fast processors, the processing of some parts of the transaction may frequently require, say, one millisecond of processor time, while the accuracy of counting the processor time used by a given process is in the order of ten milliseconds.

Therefore, a number of problems arise when attempting to estimate resource usage in a computing environment, and past efforts at such resource usage estimation have been relatively crude.

In the past, resource usage has been estimated using two methods.

The first method is achieved by varying a simulated transaction mix. This process involves conducting special runs, each with a single transaction type. For example, it is quite common to run a single transaction type, say “new-order”, one hundred thousand times whilst concurrently measuring the total time taken by the CPU to execute the aforementioned transaction type. From the data gathered it is possible to compute the average resource usage for each run, to obtain an estimate of resource usage per transaction type. For example, once the transaction type “new-order” has been run one hundred thousand times, and the total CPU time taken by the run has been collected, say, in milliseconds, then it is possible to calculate the average time taken per transaction in milliseconds of processor time per transaction.

Unfortunately, this approach provides a totally misleading estimate. Transaction resource usage in “real life” runs depend heavily on the transaction mix. That is, the actual values yielded in a real life run depend on what other types of transactions are being executed on the computing system at the same time. Different transaction mixes can change transaction resource requirements by an order of magnitude. Additionally, in real life production systems, it is not possible to control the transaction mix, so this benchmarking approach cannot be attempted on real life systems. In other words, this method is applicable only in well-controlled situations. Even in a controlled situation, this method may give an estimate that is several orders of magnitude away from the actual value, and it does not give any indication of the error of the estimate.

The second resource usage estimation method is implemented by measuring the response time of the transaction. For example, let us assume we have two transaction types, one called “stock-level” and the other called “new-order”. If the response time for, say, new-order is twice as large as the response time for stock-level, we may suspect that new-order uses approximately twice as much of a resource as stock-level. In most practical situations the quality of such an estimate is low. Such rough estimates do not help determine, for example, whether one transaction uses twice as much processor time or disk time. For example, if the transaction type new-order were to take 15 milliseconds to execute, and the transaction type stock-level were to take 20 milliseconds to execute, from these bare figures alone it is impossible to determine whether the extra 5 milliseconds could be attributed to the processor, the hard disk, or indeed any other computer resource, such as the input-output interface, or if the computing system is arranged as a distributed network, delays in network communication between separate machines could also account for this difference. That is, these resource usage estimates do not distinguish between different system resources. In addition, differences in response time may be caused by locking delays, network delays, and other factors not related to resource requirements. In other words, this method may only be used to indicate the existence of a pathological problem but not to estimate usage of computer resources with any accuracy. It will be understood that the term computer resource can refer to any hardware component, which is involved either directly or indirectly in the completion of a transaction type. This may include, but is not limited to, the central processing unit, hard disks or any other suitable storage device, input-output interfaces, and network connections. It will be understood that the term “computer resource” may also refer to any software component, or any sub-component within a larger software component. This may include, but is not limited to, individual processes or functions within a software component, or separate applications residing concurrently on the same computing system, or separate applications residing on separate computing systems.

### SUMMARY OF THE INVENTION

In a first aspect, the present invention provides a method of estimating computing system resource usage comprising the steps of obtaining utilisation data of a system resource and transaction count data as input data and applying a mathematical model to the input data to provide an estimate of resource usage for an individual transaction type within the computing environment.

The method may preferably be applied where a plurality of different transaction types are being processed concurrently.

Preferably the mathematical model employed is a linear least squares algorithm.

The linear least squares algorithm is employed because it provides a relatively simple model with known characteristics for estimating values from a series of equations.

In addition, calculations using the least squares method preferably imposes a minimal impact on computing system resources.

This method has a number of advantages.

Firstly, the method provides a much better estimate of computing resource usage, since the present invention may be applied to a system in production. That is, it may be applied to a system which is operating in a real-life environment.

Naturally, such a method is not restricted to real-life environments and may also be used in a benchmarking environment.

Secondly, the method, by obtaining statistics (transaction count data) and utilisation data that is already available within many operating systems and third party applications (particularly enterprise software) preferably imposes only a small performance penalty on the computing system on which it operates. These statistics may take the form of any suitable parameters, which may be measurable by either the user or by the computing system itself. For example, in a Unix system, it is possible to generate a list of processes, and a corresponding list of the CPU time taken to execute the aforementioned processes. In this example, we take the term statistics to mean the list of processes, and the term raw utilisation data to mean the CPU time taken by the processor/s to execute the processes.

Thirdly, the method may be applied to either hardware or software resources. Statistics may be gathered either from hardware components, or from software components. This preferably allows a programmer to identify problems that either reside in hardware components or in software components.

The present invention may preferably be applied to an analysis of the usage of any type of computer resource. The method may be applied to any type of hardware or software computer resources, on which utilisation data may be gathered. This could include, but is not limited to, the central processing unit, any type of storage device, such as hard disk drives, CD-ROM readers, tape drives, magnetic storage devices, optical storage devices, etc. It may also be applied to any other type of hardware resource which may impact on overall system performance. This may include network response times, I/O interrupt times or other system interrupts, etc. The method may also be applied to any type of computer software resource, on which utilisation data may be gathered. This may include processes or functions within a software package, or statistics from different software packages residing on the same computing system, or on separate computing systems in a distributed computing system.

Preferably, in a further embodiment, the present invention may also comprise the further method step of calculating the error estimates for the estimated resource usage for a particular transaction type.

This may be important because it provides a yardstick against which to gauge the usefulness of the resource usage estimates.

In many instances, particularly with the advent of faster computing systems, the execution time for a given process has become smaller. Therefore, it is not enough to simply estimate the resource usage values. It is also preferable to gain some knowledge regarding the accuracy of the estimates. Preferably, with the present invention, it is possible to make an informed decision on the reliability of the estimates, as the error calculations provide a guide to the accuracy of the results. For example, if the error values are comparable in magnitude to the estimated resource usage values, then it will be apparent that the estimated resource usage values should be treated with some caution. Alternatively, if the magnitude of the error values are small compared to the magnitude of the resource usage values, then it may be decided that the resource usage estimates represent an accurate estimate of the resource usage by a particular process.

In accordance with a second aspect, the present invention provides a computing system arranged to facilitate the estimation of resource usage within a computer environment, comprising a data gathering means arranged to gather raw utilisation data of a computer resource and transaction count data, a processing means arranged to apply a mathematical model to the raw input data to produce a set of output data, whereby the output data provides an estimate of resource usage of the individual transaction type within the computing environment. Preferably, the mathematical model takes the form of a linear least squares algorithm. It will be understood that any suitable statistical regression algorithm may be employed. Any statistical model which is capable of generating an estimate of the time elapsed in the execution of a single transaction type may be utilised.

In accordance with a third aspect, the present invention provides a computer program arranged when loaded on a computing system to obtain utilisation data of a system resource and transaction count data as input data and to generate an estimate of resource usage for an individual transaction type within the computing system by applying a mathematical model to the said input data.

In accordance with a fourth aspect of the present invention, there is provided a computer readable medium providing a computer program in accordance with the third aspect of the present invention.

### BRIEF DESCRIPTION OF THE DRAWINGS

Features and advantages of the present invention will become apparent from the following description of an embodiment thereof, by way of example only, with reference to the accompanying drawings, in which;

FIG. 1 is a schematic drawing of a system in accordance with our embodiment of the present invention.

FIG. 2 is a flow chart depicting a method in accordance with our embodiment of the present invention.

FIG. 3A is a table illustrating an example of the raw data used in the present invention.

FIG. 3B is a table representing an example of the relevant data extracted from the raw data of FIG. 3A.

### DESCRIPTION OF PREFERRED EMBODIMENT

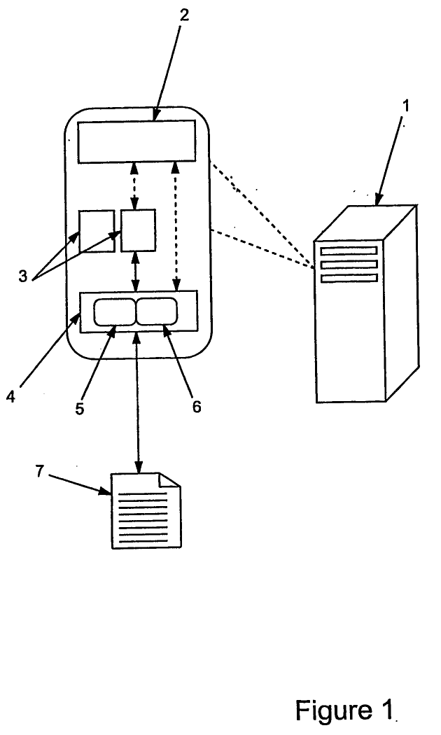

FIG. 1 illustrates a system in accordance with an embodiment of the present invention.

There is shown a computing system 1 on which runs an operating system 2, and optionally other third party applications 3.

An embodiment of the present invention 4, comprises a data gathering means 5 which interacts with either the operating system and/or the third party applications to gather transaction process data and raw system resource utilisation data.

The data gathering means may be implemented by appropriate software/hardware or by any convenient means known to the skilled person.

This data is processed using a processing means 6, which applies a least linear squares algorithm to the data, to provide a resource usage estimate 7 as output data.

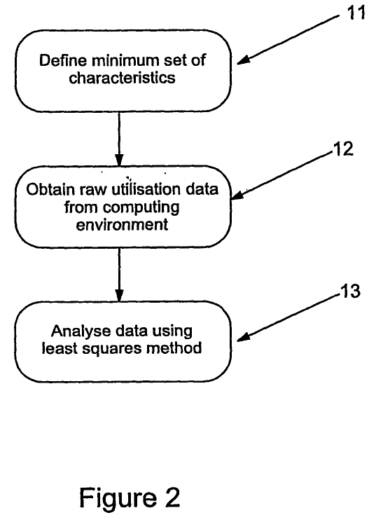

FIG. 2 shows a flow chart which illustrates the approach taken in implementing this embodiment of the present invention.

In the flow-chart of FIG. 2, the first step 11 is to define the minimum set of characteristics which are required to obtain resource usage estimates. The second step 12 consists of obtaining the values of these characteristics from the computing environment. In accordance with one embodiment of the present invention, the preferred mathematical model is the linear least squares algorithm. When implementing this algorithm, it is preferable to use a minimum set of data for the sake of efficiency. For example, in a situation where it is necessary to obtain an estimate of the processor time used by the transactions processed by the system, then at first instance it is necessary to take snap shots of the system at different time intervals. During each snap shot it is necessary to record the processor time used since the last snap shot and the number of transactions of each type processed since the last snap shot.

The third step 13 is to analyse the data obtained in the second step by applying an appropriate linear algebraic algorithm, such as the least squares algorithm.

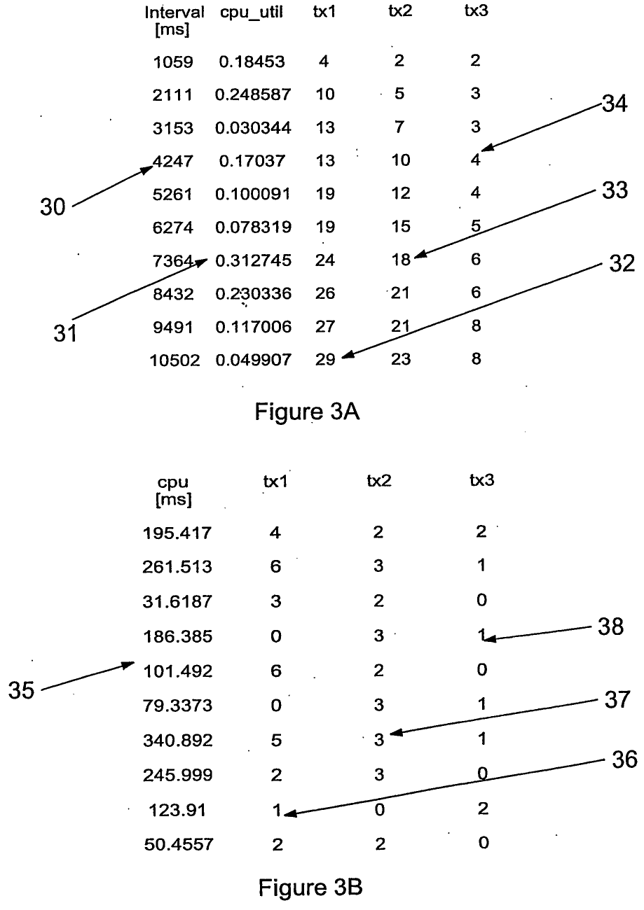

An example is now provided with reference to FIGS. 3A and 3B. In this example, raw data is obtained from an application that is integral to a contemporary computer operating system, but it is to be understood that the data may be obtained in any appropriate way. For example, it may be obtained from a facility that is integral to the operating system, from a facility that is integral to an application residing on a computing system, or alternatively the data collection process may be a facility provided with an embodiment of the present invention. Most contemporary operating systems allow a user to produce a “log” which contains information regarding the utilisation of one or more hardware resources.

Such a log, which is given by way of example only, is shown in FIG. 3A.

In FIG. 3A, the first column (30) represents a list of values of the system time when a “snapshot” of the system and application state were taken. In this context, the phrase “system time” refers to the amount of time that has passed in the interval between “snapshots”.

The second column 31 is the CPU (central processing unit) utilisation during the interval between “snapshots”. In the context of the present invention, the phrase “CPU utilisation” will be understood to mean a quantity which represents a quantitative measurement of the CPU resources used by any process or action performed by an operating system or other piece of software. The use of a “CPU resource” could include, by way of example only, the loading of variables into the CPU register, the performing of arithmetic functions by the CPU, the flushing of on-board CPU cache, or any other function which is performed exclusively by the CPU and prevents other processors or functions from accessing the CPU. Note that a “full” (ie. 100%) utilisation of a resource would be represented by the number 1.0 and therefore any lower usage by a fraction of the number 1.0. For example, a usage of 64% of CPU resources would be represented by the number 0.64. It is to be understood that the utilisation value could represent any appropriate hardware resource, such as hard disk access time, network packets, I/O interrupts, etc., and is not limited to CPU resources alone. The utilisation value could also represent any appropriate software resource, such as individual processes or functions within a larger application or different applications residing concurrently on a computing system. The third 32, fourth 33, and fifth 34 columns indicate different transactions types and represent the number of transactions (developed by counters) of a given type having been processed since system start up. It may be noted that in the present example, the data in the third, fourth and fifth columns of FIG. 3A are derived from cumulative counters. Each column, TX1, TX2 and TX3 represents a different transaction type.

For example, TX1 could represent the number of times the “stock-level” process was performed by the computing system, and TX2 may represent the number of times the process “new-order” was performed by the computing system.

FIG. 3B represents an example of data derived from the data shown in FIG. 3A. In column 30, there is shown the “interval” of time during which a number of processors have been performed. The interval,is expressed as the total cumulative time, measured from the beginning of the test run or from system start up. The interval of time between two subsequent snap shots can be obtained by subtracting the time of the given snap shot from the time of the previous snap shot.

In the present example, the time interval between two successive snap shots (in column 30) is computed to give the appropriate interval time, which is then multiplied by the CPU utilisation (in column 32) to obtain the total CPU time, (expressed in this example in milliseconds), the result being displayed in the first column 35 of FIG. 3B. The total CPU time, in the present example, will be understood to be the total time (measured in milliseconds) taken by the CPU to process the transactions shown in a row of columns 32, 33 and 34. Correspondingly, the number of any particular transaction type for the relevant time period is given in columns 36, 37, 38 (the total number of particular transaction types in a given time period is simply the total cumulative transactions processed in a given time period minus the total cumulative transactions processed in the preceding time period).

It will be understood that the data may be collected in a different form from the procedure in this example. For example, it may be possible to collect from the operating system, or directly from a hardware monitor, straight interval lengths and/or counts of transactions within a given interval. In the present example, a cumulative counter is used because it represents a common practice in real world situation, where cumulative counters are easier to implement and run.

Once the input data is transformed into this format, the table in FIG. 3B is, in effect, an overdetermined system of equations in the form A*X=B, where B represents the first column of the table and A represents a matrix comprising the remaining columns of the table.

The vector X represents a vector of coefficients giving the usage for each transaction type.

This overdetermined set of equations may be solved by the standard linear least squares solution:
X=(A^{T}*A)⁻¹*(A^{T}*B)

The linear least squares method solution embodied in the above equation is a well known method which is 15 described in many undergraduate text books [Johnson et al “Applied Multiseriate Statistical Analysis” 3rd ed Practice Hall]. In the equation given, the term A^{T} denotes the transpose of the matrix A.

Therefore, in the context of the example given in FIG. 3, the matrix A is denoted by the three columns of the table. That is, columns 32, 33 and 34 of FIG. 3B.

$$A = [ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ]$$

Matrix B represents the first column of the table that is column 35 of FIG. 3B.

$$B = [ \begin{matrix}195.417 \\ 261.513 \\ 031.6187 \\ 186.385 \\ 101.492 \\ 079.3373 \\ 340.892 \\ 245.999 \\ 123.91 \\ 050.4557\end{matrix} ]$$

Therefore, substituting into the standard linear leased squares solution we obtain the following equation:

$$X = {( {[ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ]}^{T} * [ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ] )}^{- 1} * ( [ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ] * [ \begin{matrix}195.417 \\ 261.513 \\ 31.6187 \\ 186.385 \\ 101.492 \\ 79.3373 \\ 340.892 \\ 245.999 \\ 123.91 \\ 50.4557\end{matrix} ] )$$

Solving this equation, we find that the values for X are
X={13.0585, 39.2245, 50.4133},
suggesting that the processor usage for type 1 processes is approximately 13 ms, for type 2 processes the value is approximately 39 ms, and for type 3 processes the value is approximately 50 ms. As a result of the described method, there has now been derived an estimate of the resource usage of specific transactions types for a given computer system. As a result, an operating engineer or programmer can now evaluate problems and set up a systems network for more efficient operation.

In another embodiment the present invention may also be used to estimate the resource usage of software sub-systems. Contemporary applications use multiple software sub-system. For example, a person selling items via a website requires a computing system, database, and a transaction processor (in addition to auxiliary sub-systems such as a remote credit card checking system).

An embodiment of the present invention allows a user to access statistics on software sub-system usage by transaction types on two levels:
1. Division of computer resources used between sub-systems (for example, how much time a transaction spends in the web server versus how much time a transaction spends in the database).
2. Within a sub-system (how much time is spent writing to a database versus how much time is spent reading from a database)

Large computer sub-systems (for example, database programs) almost always consist-of several cooperating processors running concurrently on a computing system. Therefore, in a simplified example, a database may consist of four processors:
1. Reading—reading the required data from database files
2. Writing—writing the updated data to a database file
3. Log Writing—writing transaction data to a recovery log
4. Managing—coordinating the work of all processors.

In such a database system, an embodiment of the present invention enables system administrators to obtain global system resource usage data (for example, total processor time per transaction time).

Referring to our example database, it may be useful to a user to know if given transaction times are using mostly the reading process or the writing process or some other process of the database. Such information will suggest which parts of the underlying application are overloaded by which transaction. For example, referring back to our original example, the stock level transaction type may have reasonably small overall processor time requirements suggesting that other transactions should be tuned. However, if a user is aware that almost all of this time is spent in the writing process, then the user may realise that the writing process is a very costly operation in terms of other system resources (for example, disc usage, IO channels, etc). Hence information on which parts of the application are used by each transaction type is important in the tuning and administration of a computing system. This information can be obtained using a similar approach to the original one, by collecting a different kind of data. Instead of overall processor time, for example, it is now important to collect data for individual processors within the underlying application. The least squares method, or another appropriate mathematical model, may then be applied to solve the system of equations for each characteristic of the individual process of the database which allows a user to obtain an estimate of how much work from this individual process a transaction type requires.

It shall be understood that the present invention shall not be limited to a single or standalone computer, but that the term “computing system” may encompass a number of computers joined together by any suitable networking means, such as a direct connection through a proprietary network, or via any public or semi-public network such as the Internet. In addition, it shall be understood that the present invention is not limited to a computing system with a single CPU (central processing unit) but may be equally applied to a computing system with any number of central processing units. Modifications and variations as would be apparent to a skilled addressee are deemed to be within the scope of the present invention.

1. A method of estimating computing system resource usage of each individual transaction type in a computing system arranged to process a plurality of transaction types within a given time interval, comprising the steps of, obtaining a plurality of samples of raw utilisation data of a system resource and a corresponding plurality of samples of transaction count data for a plurality of transaction types, and applying a mathematical model to the data to provide an estimate of the resource usage for each individual transaction type of the multiple transaction types within the computing environment.

2. A method in accordance with claim 1, wherein the method comprises the further preliminary step of determining the minimum set of characteristics required to provide said estimate.

3. A method in accordance with claim 1, wherein the said mathematical model is a linear least squares algorithm.

4. A method in accordance with claim 1, comprising the further step of estimating error values for the estimates of the said resource usage for an individual transaction type within the computing environment.

5. A method in accordance with claim 1, wherein the said system resource is the processing time of the CPU.

6. A method in accordance with claim 1, wherein the said system resource is a storage device access time.

7. A method in accordance with claim 1, wherein the said system resource is the number of I/O completions minus the number of interrupts.

8. A method in accordance with claim 1, wherein the said system resource is the number of system interrupts.

9. A method in accordance with claim 1, wherein the said system resource is the number of network packets.

10. A method in accordance with claim 1, wherein the said system resource is a system memory cache.

11. A method in accordance with claim 1, wherein the said system resource is a software sub-system resource.

12. A method in accordance with claim 1, wherein the said system resource is a function within a software sub-system.

13. A method in accordance with claim 1, wherein the said system resource is a software package.

14. A computing system arranged to facilitate the estimation of resource usage of each individual transaction type within a computer environment arranged to process a plurality of transaction types, comprising a data gathering means arranged to gather raw utilisation data of a computer resource and transaction count data, a processing means arranged to apply a mathematical model to the raw input data to produce a set of output data, whereby the output data provides an estimate of resource usage of the each individual transaction type within the computing environment.

15. A computer program arranged when loaded on a computing system to perform the method of claim 1.

16. A computer readable medium providing a computer program in accordance with claim 15.
